(19) United States
(12) Patent Application Publication
(10) Pub. No.: US 2006/0244714 A1
(43) Pub. Date: Nov. 2, 2006

(54) Driving circuit and driving method for an electrophoretic display

(75) Inventors: Guofu Zhou, Eindhoven (NL); Peter Alexander Duine, Eindhoven (NL); Mark Thomas Johnson, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,736

(22) PCT Filed: May 19, 2004
(86) PCT No.: PCT/IB04/50747

§ 371 Date: Nov. 29, 2005

(30) Foreign Application Priority Data
Jun. 2, 2003 (EP) 03101585.2

(51) Int. Cl. G09G 3/34

(52) U.S. Cl. 345/107

(57) ABSTRACT

A driving circuit for an electrophoretic display has a plurality of pixels (18) of an electrophoretic material which comprises charged particles (8, 9). The pixels (18) are associated with a respective first electrode (6) and second electrode (5, 5′) which present a drive voltage (VD) to the pixels (18) to at least enable the charged particles (8, 9) to occupy one of two limit positions between the first electrode (6) and the second electrode (5, 5′). The driving circuit comprises an addressing circuit (16, 10) which generates the drive voltage (VD) by applying between the first electrode (6) and the second electrode (5, 5′): (i) an reset pulse (RE) which has an energy content sufficient or larger than required for the charged particles (8, 9) to reach one of the limit positions, and (ii) a shaking pulse (SP1) which at least partially overlaps the reset pulse (RE). The shaking pulse SP1 has, during the reset pulse (RE), at least partially a level with an opposite polarity than a level of the reset pulse (RE). The shaking pulse (SPI) comprises at least one preset pulse (PR) having an energy sufficient to release the charged particles (8, 9) present in one of the limit positions, but insufficient to enable said particles (8, 9) to reach the other one of the limit positions.

The invention relates to an electrophoretic display, a driving circuit for such an electrophoretic display, a display apparatus comprising such an electrophoretic display, and a method of driving such an electrophoretic display.

A display device of the type mentioned in the opening paragraph is known from international patent application WO 99/53373. This patent application discloses an electronic ink display (also referred to as E-ink display) which comprises two substrates, one of which is transparent, the other substrate is provided with electrodes arranged in rows and columns. Display elements or pixels are associated with intersections of the row and column electrodes. Each display element is coupled to the column electrode via a main electrode of a thin-film transistor (further referred to as TFT). A gate of the TFT is coupled to the row electrode. This arrangement of display elements, TFT's and row and column electrodes jointly forms an active matrix display device.

Each pixel comprises a pixel electrode which is the electrode of the pixel which is connected via the TFT to the column electrodes. During an image update period or image refresh period, a row driver is controlled to select all the rows of display elements one by one, and the column driver is controlled to supply data signals in parallel to the selected row of display elements via the column electrodes and the TFT's. The data signals correspond to image data to be displayed.

Furthermore, an electronic ink is provided between the pixel electrode and a common electrode provided on the transparent substrate. The electronic ink is thus sandwiched between the common electrode and the pixel electrodes. The electronic ink comprises multiple microcapsules of about 10 to 50 microns. Each microcapsule comprises positively charged white particles and negatively charged black particles suspended in a fluid. When a positive voltage is applied to the pixel electrode with respect to the common electrode, the white particles move to the side of the microcapsule directed to the transparent substrate, and the display element appears white to a viewer. Simultaneously, the black particles move to the pixel electrode at the opposite side of the microcapsule where they are hidden from the viewer. By applying a negative voltage to the pixel electrode with respect to the common electrode, the black particles move to the common electrode at the side of the microcapsule directed to the transparent substrate, and the display element appears dark to a viewer. When the electric field is removed, the display device remains in the acquired state and exhibits a bi-stable character. This electronic ink display with its black and white particles is particularly useful as an electronic book.

Grey scales can be created in the display device by controlling the amount of particles that move to the common electrode at the top of the microcapsules. For example, the energy of the positive or negative electric field, defined as the product of field strength and time of application, controls the amount of particles which move to the top of the microcapsules.

The known display device has the drawback that the appearance of a pixel depends on the history of the voltages supplied across the pixel.

From the non-pre-published patent applications in accordance to applicants docket referred to as PHNL020441 and PHNL030091 which have been filed as European patent applications 02077017.8 and 03100133.2 it is known to minimize the image retention by using preset pulses (also referred to as the shaking pulse). Preferably, the shaking pulse comprises a series of AC-pulses, however, the shaking pulse may comprise a single preset pulse only. The non-pre-published patent applications are directed to the use of shaking pulses, either directly before the drive pulses, or directly before the reset pulse. A reset pulse has an energy which is sufficient to bring the pixel into one of two limit optical states. PHNL030091 further discloses that the picture quality can be improved by extending the duration of the reset pulse which is applied before the drive pulse. The reset period now comprises a reset pulse and an over-reset pulse. This over-reset pulse, when added to the standard reset pulse, results in an over-reset energy which is larger than required to bring the pixel into one of two limit optical states. The duration of the over-reset pulse may depend on the required transition of the optical state.

For example, if black and white particles are used, the two limit optical states are black and white. In the limit state black, the black particles are at a position near to the transparent substrate, in the limit state white, the white particles are at a position near to the transparent substrate.

The drive pulse has an energy to change the optical state of the pixel to a desired level which may be in-between the two limit optical states. Also the duration of the drive pulse may depend on the required transition of the optical state.

The non-prepublished patent application PHNL030091 discloses in an embodiment that the shaking pulse precedes the reset pulse. Each level (which is one preset pulse) of the shaking pulse has a duration sufficient to release particles present in one of the extreme positions, but insufficient to enable said particles to reach the other one of the extreme positions. The shaking pulse increases the mobility of the particles such that the reset pulse has an immediate effect If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present.

The driving of the electrophoretic display in accordance with the present invention differs from the driving disclosed in the non-prepublished patent application PHNL030091 in that the shaking pulse occurs at least partially during the reset pulse.

A first aspect of the invention provides a driving circuit for an electrophoretic display as claimed in claim 1. A second aspect of the invention provides a display apparatus as claimed in claim 11. A third aspect of the invention provides a method of driving an electrophoretic display as claimed in claim 12. Advantageous embodiments of the invention are defined in the dependent claims.

As discussed earlier, the shaking pulse may comprise a single preset pulse or a series of preset pulses. If the shaking pulse comprises a single preset pulse this preset pulse occurs at least partially during the reset period. If the shaking pulse comprises several preset pulses, at least one of these preset pulses occurs at least partially during the reset period. If only one preset pulse is (partially) present during the reset period, this preset pulse needs to have a polarity which is opposite to the polarity of the reset pulse to have the shaking effect. If several preset pulses are present during the reset period, preferably the polarity of the preset pulses alternates.

Because, in accordance with the first aspect of the invention, the shaking pulse occurs at least partially during the reset period, the image update period becomes shorter, while still the image retention is decreased. The image update period is the period of time required to update the optical state of all the pixels in accordance with an image to be displayed. In today's electrophoretic displays, the image update period lasts about a second. Usually, the image update period comprises successively the shaking pulse, the reset pulse, and a drive pulse. The image update period may comprise further pulses. For example, further shaking pulses may be present between the reset period and the drive pulse. A shorter image update period has the advantage that the user needs to wait less if the image has to change, and that the display of fast changing information becomes more practical. However, the use of this idea of overlapping at least part of the shaking pulse with the reset pulse is not limited to a fall image update period. It is also beneficial if the electrophoretic display has to be resetted only.

In an embodiment in accordance with the invention as claimed in claim 2, the reset period comprises both an over-reset pulse and a reset pulse, whereby the picture quality may be improved. If further is referred to the reset pulse this may either refer to the reset pulse alone, or the over-reset pulse combined with the reset pulse.

In an embodiment in accordance with the invention as claimed in claim 3, the shaking pulse comprises several preset pulses. A first number of the preset pulses occurs before the reset pulse and a second number of the preset pulses occurs during the reset pulse. The advantage of still having preset pulses preceding the reset pulse is to eliminate the effect of dwell time so that the reset pulse takes effects immediately and the disturbance of reset can also be reduced.

In an embodiment in accordance with the invention as claimed in claim 4, all the preset pulses are generated during the reset pulse. Now, the duration of the image update period is minimal.

In an embodiment in accordance with the invention as claimed in claim 5, two successive preset pulses with a polarity opposite to the polarity of the reset pulse occur during the reset period separated by a separation period of time. The disturbance of the reset pulse is less than that the preset pulses occur immediately adjacent with alternating polarity.

In an embodiment in accordance with the invention as claimed in claim 6, the preset pulses have a duration equal to the frame period. The frame period is the time required to select all the pixels of the display line by line.

In an embodiment in accordance with the invention as claimed in claim 7, the duration of the preset pulses is longer than the frame period. These longer preset pulses further reduce the image retention, especially when the electrophoretic material has a strong dependence on the image history and/or dwell time.

In an embodiment in accordance with the invention as claimed in claim 8, the shaking pulse which at least partially occurs during the reset pulse is applied during a usual image update period wherein the drive pulse succeeds the reset pulse.

In an embodiment in accordance with the invention as claimed in claim 9, a further shaking pulse is present in-between the reset pulse and the drive pulse. This has the advantage that the image retention decreases.

In an embodiment in accordance with the invention as claimed in claim 10, the preset pulses of the at least partially overlapping shaking pulse have a duration which is longer than a duration of the preset pulses of the shaking pulse which is present in-between the reset pulse and the drive pulse. These longer preset pulses further reduce the image retention, especially when the electrophoretic material has a strong dependence on the image history and/or dwell time.

These and other aspects of the invention are apparent from and will be elucidated with reference to the embodiments described hereinafter.

In the drawings:

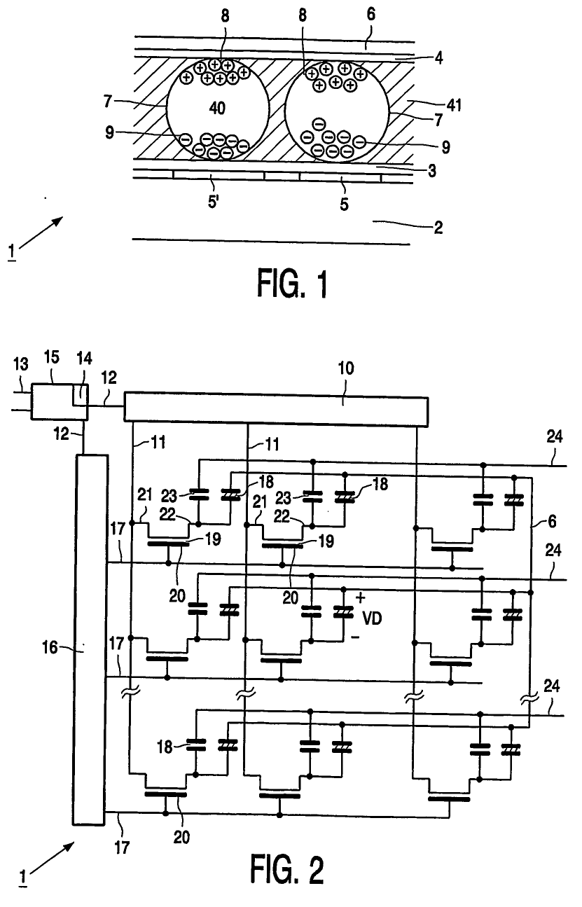

FIG. 1 shows diagrammatically a cross-section of a portion of an electrophoretic display,

FIG. 2 shows diagrammatically a picture display apparatus with an equivalent circuit diagram of a portion of the electrophoretic display,

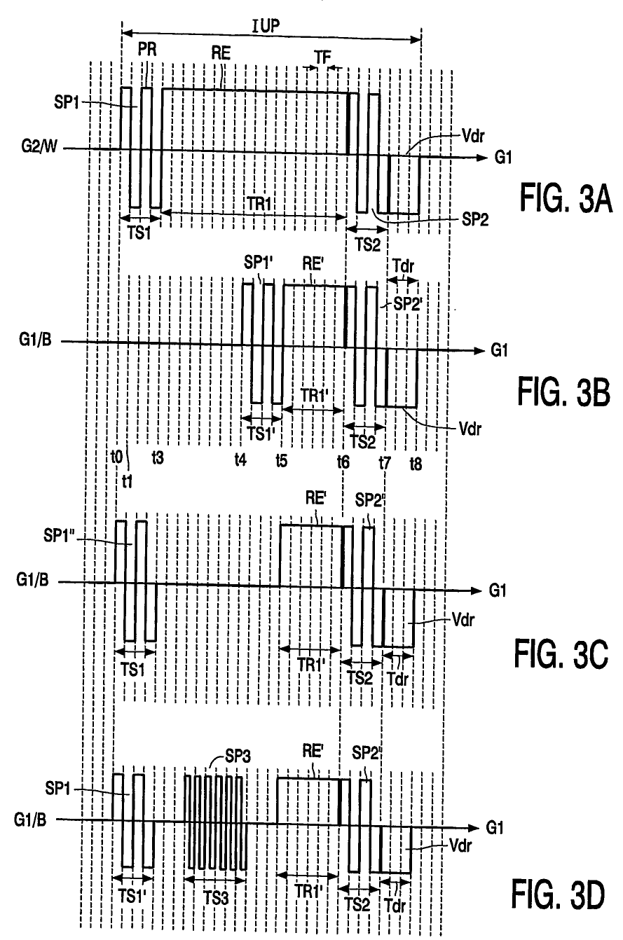

FIG. 3 shows voltages across a pixel in different situations wherein a reset pulse and various shaking pulses are used,

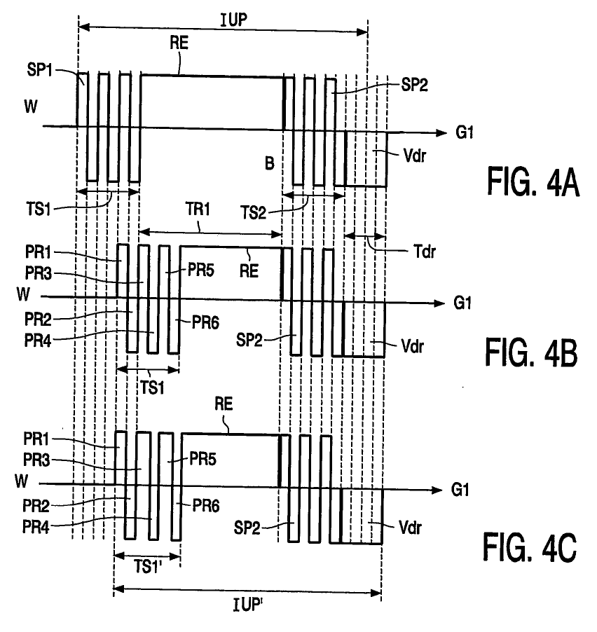

FIG. 4 shows an embodiment in accordance with the invention wherein the shaking pulse partially overlaps the reset pulse,

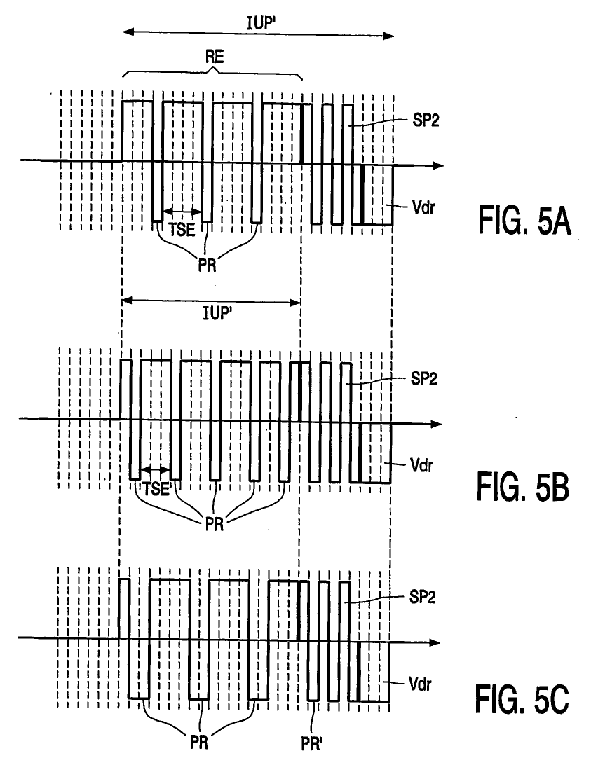

FIG. 5 shows embodiments in accordance with the invention wherein the shaking pulse occurs during the reset pulse, and

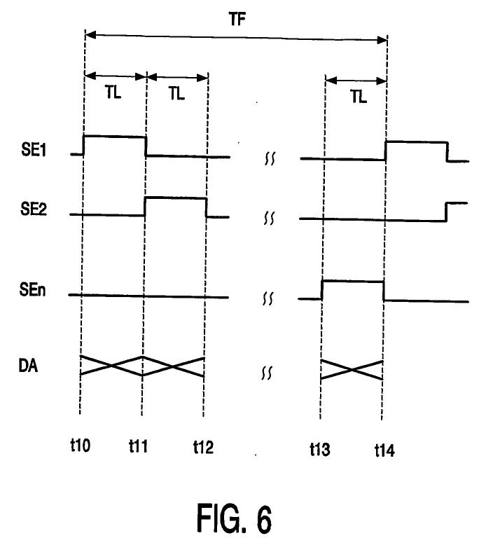

FIG. 6 shows signals occurring during a frame period.

FIG. 1 shows diagrammatically a cross-section of a portion of an electrophoretic display, for example, only of the size of a few display elements, comprising a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 2) is supplied as a positive drive voltage Vdr (see, for example, FIG. 3) to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage Vdr between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8, 9 remain in the acquired state and the display exhibits a bi-stable character and consumes substantially no power. Electrophoretic media are known per se from e.g. U.S. Pat., No. 5,961,804, U.S. Pat. No. 6,1120,839 and U.S. Pat. No. 6,130,774 and may be obtained from E-ink Corporation.

FIG. 2 shows diagrammatically a picture display apparatus with an equivalent circuit diagram of a portion of the electrophoretic display. The picture display device I comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. The counter electrode 6 may be segmented. Usually, the active switching elements 19 are thin-film transistors TFT. The display device 1 comprises a matrix of display elements associated with intersections of row or selection electrodes 17 and column or data electrodes 11. The row driver 16 consecutively selects the row electrodes 17, while the column driver 10 provides data signals in parallel to the column electrodes 11 for the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 16 supplies an appropriate select pulse to the gates of the TFT's 19 which are connected to the particular row electrode 17 to obtain a low impedance main current path of the associated TFT's 19. The gates of the TFT's 19 which are connected to the other row electrodes 17 receive voltages such that their main current paths have a high impedance. The low impedance between the source electrodes 21 and the drain electrodes of the TFT's allows the data voltages present at the column electrodes 11 to be supplied to the drain electrodes which are connected to the pixel electrodes 22 of the pixels 18. In this manner, a data signal present at the column electrode 11 is transferred to the pixel electrode 22 of the pixel or display element 18 coupled to the drain electrode of the TFT if the TFT is selected by an appropriate level on its gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc.

FIG. 3 shows voltages across a pixel in different situations wherein a reset pulse is used. By way of example, FIGS. 3 are based on an electrophoretic display with black and white particles and four optical states: black B, dark grey G1, light grey G2, white W. FIG. 3A shows an image update period IUP for a transition from light grey G2 or white W to dark grey G0. FIG. 3B shows an image update period IUP for a transition from dark grey GI or black B to dark grey G1. The vertical dotted lines represent the frame periods TF (which usually last 20 milliseconds), the line periods TL occurring within the frame periods TF are not shown in FIGS. 3 to 5. The line periods TL are illustrated in FIG. 6.

In both FIG. 3A and FIG. 3B, the pixel voltage VD across a pixel 18 comprises successively first shaking pulses SP1, SP1′, a reset pulse RE, RE′, second shaking pulses SP2, SP2′ and a drive pulse Vdr. The drive pulses Vdr occur during the same drive period Tdr which lasts from instant t7 to instant t8. The second shaking pulses SP2, SP2′ immediately precede the driving pulses Vdr and thus occur during a same second shaking period TS2. The reset pulse RE, RE′ immediately precede the second shaking pulses SP2, SP2′. However, due to the different duration TR1, TR1′ of the reset pulses RE, RE′, respectively, the starting instants t3 and t5 of the reset pulses RE, RE′ are different. The first shaking pulses SP1, SP1′ which immediately precede the reset pulses RE, RE′, respectively, thus occur during different first shaking periods in time TS1, TS1′, respectively.

The second shaking pulses SP2, SP2′ occur for every pixel 18 during a same second shaking period TS2. This enables to select the duration of this second shaking period TS2 much shorter as is shown in FIGS. 3A and 3B. For clarity, each one of levels of the second shaking pulses SP2, SP2′ is present during a standard frame period TF. In fact, during the second shaking period TS2, the same voltage levels can be supplied to all the pixels 18. Thus, instead of selecting the pixels 18 line by line, it is now possible to select all the pixels 18 at once, and only a single line select period TL (see FIG. 6) suffices per level. Thus, in the embodiment in accordance with the invention shown in FIGS. 3A and 3B, the second shaking period TS2 only needs to last four line periods TL instead of four standard frame periods TF. It is still possible to select all the pixels during a longer period than a single line period to decrease the power consumption. It is also possible to select successively groups of rows of pixels to lower the capacitive currents required to charge the pixels.

Alternatively, it is also possible to change the timing of the drive signals such that the first shaking pulses SP1 and SP1′ are aligned in time, the second shaking pulses SP2 are then no longer aligned in time (not shown). Now the duration of the first shaking period TS1 can be much shorter or it is possible to decrease the power consumption.

The driving pulses Vdr are shown to have a constant duration, however, the drive pulses Vdr may have a variable duration.

If the drive method shown in FIGS. 3A and 3B is applied to the electrophoretic display, outside the second shaking period TS2, the pixels 18 have to be selected line by line by activating the switches 19 line by line. The voltages VD across the pixels 18 of the selected line are supplied via the column electrodes 11 in accordance with the optical state the pixel 18 should have. For example, for a pixel 18 in a selected row of which pixel the optical state has to change from white W to dark grey G1, a positive voltage has to be supplied at the associated column electrode 11 during the frame period TF starting at instant t0. For a pixel 18 in the selected row of which pixel the optical state has to change from black B to dark grey G1, a zero voltage has to be supplied at the associated column electrode during the frame period TF lasting from instants t0 to t1.

FIG. 3C shows a waveform which is based on the waveform shown in FIG. 3B. This waveform of FIG. 3C causes the same optical transition. The difference is that the first shaking pulses SP1′ of FIG. 3B are now shifted in time to coincide with the shaking pulses SP1 of FIG. 3A. The shifted shaking pulses SP1′ are indicated by SP1″. Thus, now, independent on the duration of the reset pulse RE, also all the shaking pulses SP1, SP1″ occur during the same shaking period TS1. This has the advantage that independent of the optical transition, the same shaking pulses SP1, SP1″ and SP2, SP2′ can be supplied to all pixels 18 simultaneously. Thus both during the first shaking period TS1 and the second shaking period TS2, it is not required to select the pixels 18 line by line. Whilst in FIG. 3C the shaking pulses SP1″ and SP2′ have a predetermined high or low level during a complete frame period, it is possible to use shaking pulses SP1″ and SP2′ lasting one or more line periods TL (see FIG. 6). In this manner, the image update time may be shortened. Further, due to the selection of all (or groups of) lines at the same time and providing a same voltage to all columns, during the shaking periods TS1 and TS2, the parasitic capacitances between neighboring pixels and electrodes will have no effect This will minimize stray capacitive currents and thus dissipation. Even further, the common shaking pulses Sp1, Sp1″ and SP2, SP2′ enable implementing shaking by using structured counter electrodes 6. The dissipation will be lowered if a same shaking pulse is supplied to all pixels 18 of the same column, wherein different columns may receive different shaking pulses.

A disadvantage of this approach is that a small dwell time is introduced (between the first shaking pulse period TS1 and the reset period TR1′). Dependent on the electrophoretic display used, this dwell time should not become longer than, for example, 0.5 seconds.

FIG. 3D shows a waveform which is based on the waveform shown in FIG. 3C. To this waveform third shaking pulses SP3 are added which occur during a third shaking period TS3. The third shaking period TS3 occurs between the first shaking pulses Sp1 and the reset pulse RE′, if this reset pulse RE′ does not have its maximum length. The third shaking pulses SP3 may have a lower energy content than the first shaking pulses Sp1 to minimize the visibility of the shaking. It is also possible that the third shaking pulses SP3 are a continuation of the first shaking pulses SP1. Preferably, the third shaking pulses SP3 fill up the complete period in time available between the first shaking period TS1′ and the reset period TR1′ to minimize the image retention and to increase the grey scale accuracy. With respect to the embodiment in accordance with the invention shown in FIG. 3C, the image retention is further reduced and the dwell time is massively reduced.

Alternatively, it is possible that the reset pulse RE′ occurs immediately after the first shaking pulses SP1 and the third shaking pulses occur between the reset pulse RE′ and the second shaking pulses SP2′.

The shaking pulses which at least partially overlap the reset pulse in accordance with the invention may be applied to any of the situations shown in one of the FIGS. 3A to 3D. It is even possible to apply the invention to a drive cycle of the electrophoretic display which is not an image update cycle but, for example a reset cycle only.

Several embodiments in accordance with the invention of shaking pulses which partially overlap the reset pulse are shown in FIGS. 4 and 5.

FIG. 4 shows an embodiment in accordance with the invention wherein the shaking pulse partially overlaps the reset pulse. FIG. 4A is identical to FIG. 3A and is thus not further elucidated. For the optical transition from white W to dark grey GI the reset pulse RE needs to have the duration TR1 shown in FIG. 4A. For other optical transitions the reset pulse RE may have a different duration. FIG. 4B shows that, for the same optical transition, the first shaking pulse SP1 partly overlaps the reset pulse RE. Or said in other words, the staring part of the reset pulse RE is replaced by the last part of the first shaking pulse Sp1. In this example, the shaking pulse Sp1 comprises 6 preset pulses PR1 to PR6 which alternate in polarity. The first preset pulse PR1 has the same polarity as the reset pulse RE. The first and the second preset pulses or levels PR1 and PR2 occur before the start of the reset pulse RE. The other 4 preset pulses PR3 to PR6 occur during the reset pulse RE. Consequently, the image update time IUP decreased to IUP′. In this example, the new image update time IUP′ is four times the duration of one preset pulse PR shorter than the original image update time IUP. The duration of one preset pulse PR is usually equal to one frame period TF.

FIG. 4C shows that, for the same optical transition, the first shaking pulse Sp1 partly overlaps the reset pulse RE. Or said in other words, the starting part of the reset pulse RE is replaced by the last part of the first shaking pulse Sp1. In this example, the shaking pulse Sp1 comprises 6 preset pulses PR: the first preset pulse PR1 has the same polarity as the reset pulse RE. The first and the second preset pulses PR1 and PR2 occur before the start of the reset pulse RE. The other preset pulses PR4 and PR6 occur during the reset pulse RE. The duration of the preset pulses PR3 and PR5 which have the same polarity as the reset pulse RE have a longer duration than the preset pulse PR2, PR4 and PR6 which have the opposite polarity. Consequently, the image update time IUP decreased to IUP′. In this example, the new image update time IUP′ is four times the duration of one preset pulse PR shorter than the original image update time IUP. The duration of one preset pulse PR is usually equal to one frame period TF.

FIG. 5 shows embodiments in accordance with the invention wherein the shaking pulse occurs during the reset pulse.

FIG. 5A shows an example of preset pulses PR occurring completely during the reset period RE. In this example, three preset pulses PR with a polarity opposite to the polarity of the reset pulse RE are present. Successive preset pulses PR are separated by a separation time period TSE which has a duration longer than the duration of the preset pulses PR. As now the complete shaking pulse Sp1 occurs during the reset pulse RE, the minimal possible image update period IUP″ is reached for this particular optical transition. This image update period IUP″ is only determined by the duration of the reset pulse RE required for the particular optical transition and the duration of other pulses, if present. If a reset-only cycle is performed, no other pulses are present. If an image update cycle is performed, at least a drive pulse Vdr will be present. It is also possible that a further shaking pulse SP2 is present inbetween the reset pulse RE and the drive pulse Vdr, as is shown in FIG. 5A. Thus in fact, the reset pulse RE has still the original duration TR1 but is interrupted by the preset pulses PR.

FIG. 5B differs from FIG. 5A in that, during the reset pulse RE more preset pulses PR are present. Because the preset pulses PR are present during the reset pulse RE it is possible to increase the number of preset pulses PR to further decrease the image retention without increasing the duration of the image update period IUP″. Again, it is possible to have two successive preset pulses PR separated by a separation time period TSE′ which has a duration longer than the duration of the preset pulses PR FIG. 5C differs from FIG. 5A in that the duration of the preset pulses is two frames instead of one frame. This has the advantage that these prolonged AC-pulses reduce the image retention, especially when the electrophoretic material (for example the E-ink) has a strong dependence on the image history and/or dwell time. It is not essential to this embodiment in accordance with the invention that duration of the preset pulses PR is exactly two frame periods TF, any duration longer than one frame period TF will reduce the image retention and improve the image quality.

FIG. 6 shows signals occurring during a frame period. Usually, each frame period TF indicated in FIGS. 3 to 5 comprises a number of line periods TL which is equal to a number of rows of the electrophoretic matrix display. In FIG. 6, one of the successive frame periods TF is shown in more detail. This frame period TF starts at the instant t10 and lasts until instant t14. The frame period TF comprises n line periods TL. The first line period TL lasts from instant t10 to t11, the second line period TL lasts from instant t11 to t12, and the last line period TL lasts from instant t13 to t14.

Usually, during the frame period TF, the rows are selected one by one by supplying appropriate select pulses SE1 to SEn to the rows. A row may be selected by supplying a pulse with a predetermined non-zero level, the other rows receive a zero voltage and thus are not selected. The data DA is supplied in parallel to all the pixels 18 of the selected row. The level of the data signal DA for a particular pixel 18 depends on the optical state transition of this particular pixel 18.

Thus, if different data signals DA may have to be supplied to different pixels of a selected row, the frame periods TF shown in FIGS. 3 to 5 comprise the n line or select periods TL. However, if the first and second shaking pulses Sp1 and SP2 occur during the same shaking periods TS1 and TS2, respectively, for all the pixels 18 simultaneously, it is possible to select all the lines of pixels 18 simultaneously and it is not required to select the pixels 18 line by line. Thus, during the frame periods TF shown in FIGS. 3 and 6 wherein common shaking pulses are used, it is possible to select all the pixels 18 in a single line period TL by providing the appropriate select pulse to all the rows of the display. Consequently, these frame periods may have a significantly shorter duration (one line period TL, or a number of line periods less than n, instead of n) than the frame periods wherein the pixels 18 may receive different data signals.

By way of example, the addressing of the display is elucidated in more detail with respect to FIG. 3C. At the instant t0 a first frame period TF of an image update period IUP starts. The image update period ends at the instant t8.

The first shaking pulses SP1′ are supplied to all the pixels 18 during the first shaking period TS1 which lasts from instant t0 to instant t3. During this first shaking period TS1, during each frame period TF, all the lines of pixels 18 are selected simultaneously during at least one line period TL and the same data signals are supplied to all columns of the display. The level of the data signal is shown in FIG. 3C. For example, during the first frame period TF lasting from instant t0 to t1, a high level is supplied to all the pixels. During the next frame period TF starting at instant t1, a low level is supplied to all the pixels. A same reasoning is valid for the common second shaking period TS2.

The duration of the reset pulse RE, RE′ may be different for different pixels 18 because the optical transition of different pixels 18 depends on the image displayed during a previous image update period IUP and the image which should be displayed at the end of the present image update period IUP. For example, a pixel 18 of which the optical state has to change from white W to dark grey G1, a high level data signal DA has to be supplied during the frame period TF which starts at instant t3, while for a pixel 18 of which the optical state has to change from black B to dark grey G1, a zero level data signal DA is required during this frame period. The first non-zero data signal DA to be supplied to this last mentioned pixel 18 occurs in the frame period TF which starts at the instant t4. In the frames TF wherein different data signals DA may have to be supplied to different pixels 18, the pixels 18 have to be selected row by row.

Thus, although all the frame periods TF in FIGS. 3 to 5 are indicated by equidistant vertical dotted lines, the actual duration of the frame periods may be different. In frame periods TF in which different data signals DA have to be supplied to the pixels 18, usually the pixels 18 have to be selected row by row and thus n line select periods TL are present. In frame periods TF in which the same data signals DA have to be supplied to all the pixels 18, the frame period TF may be as short as a single line select period TL. However, it is possible to select all the lines simultaneously during more than a single line select period TL to decrease the power consumption. It is possible to select all the lines (or a group of lines) at the same time if the signals to be supplied to each one of the columns are the same for all pixels of one of the columns, the signals supplied to different columns may differ.

The implementation of the embodiments in accordance with the invention as illustrated in FIGS. 4 and 5 in the picture display apparatus shown in FIG. 2 is straightforward to the skilled person and therefore not explained in detail. The control of the row driver 16 and the column driver 10 by the processor 15 is adapted such that the desired voltage level is applied between the pixel electrodes 5, 5′ and the counter electrode 6 as shown in FIGS. 4 to 5. Thus, with respect to the known display apparatus, only the timing of when which level has to be applied to which pixel 18 has been changed to obtain the waveforms shown.

It should be noted that the above-mentioned embodiments illustrate rather than limit the invention, and that those skilled in the art will be able to design many alternative embodiments without departing from the scope of the appended claims. For example, the second shaking pulses SP2 need not be present. Although in the figures, is referred to shaking pulses, each of which comprises several levels or preset pulses, it is possible that the shaking pulses comprise a single level or preset pulse only.

The present invention is also applicable to voltage modulation driving wherein the levels of the shaking pulses, the reset pulses and the drive pulses may vary.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driving circuit for an electrophoretic display with a plurality of pixels (18) having an electrophoretic material comprising charged particles (8, 9), the pixels (18) being associated with a respective first electrode (6) and second electrode (5, 5′) for presenting drive voltage waveforms (VD) across the pixels (18) for at least enabling the charged particles (8, 9) to occupy one of two limit positions between the first electrode (6) and the second electrode (5, 5′),
the driving circuit comprising an addressing circuit (16, 10) for generating the drive voltage waveforms (VD) comprising:
(i) a reset period comprising a reset pulse (RE) having an energy content being sufficient for the charged particles (8, 9) to reach one of the limit positions, and
(ii) a shaking pulse (SP1) occurring at least partially during the reset pulse (RE), and having during the reset pulse (RE) at least partially a level with an opposite polarity than a level of the reset pulse (RE), the shaking pulse (SP1) comprising at least one preset pulse (PR) having an energy sufficient to release the charged particles (8, 9) present in one of the limit positions but insufficient to enable said particles (8, 9) to reach the other one of the limit positions.

2. A driving circuit for an electrophoretic display as claimed in claim 1, wherein the addressing circuit (16, 10) is arranged for generating the reset period further comprising an over-reset pulse, which when added to the reset pulse, results in an over-reset energy which is larger than required to bring the pixel into one of two limit optical states.

3. A driving circuit for an electrophoretic display as claimed in claim 1, wherein the addressing circuit (16, 10) is arranged for generating the shaking pulse (SP1) having a first predetermined number (N1) of preset pulses (PR) occurring before a start of the reset pulse (RE) and a second predetermined number (N2) of preset pulses (PR) during the reset pulse (RE).

4. A driving circuit for an electrophoretic display as claimed in claim 1, wherein the addressing circuit (16, 10) is arranged for applying all the preset pulses of the shaking pulse (SP) during the reset pulse (RE) to interrupt the reset pulse during the at least one preset pulse (PR).

5. A driving circuit for an electrophoretic display as claimed in claim 1, wherein the addressing circuit (16, 10) is arranged for generating during the reset pulse (RE) at least two preset pulses (PR) with a polarity opposite to the polarity of the reset pulse (RE), the two preset pulses (PR) being separated from each other by a separation time period (TSE) lasting longer than a duration of the preset pulses (PR).

6. A driving circuit for an electrophoretic display as claimed in claim 1, wherein the addressing circuit (16, 10) is arranged for generating the at least one preset pulse (PR) having a duration substantially equal to a frame period (TF) during which all lines of pixels (18) are addressed one by one.

7. A driving circuit for an electrophoretic display as claimed in claim 1, wherein the addressing circuit (16, 10) is arranged for generating the at least one preset pulse (PR) having a duration substantially longer than a frame period (TF) during which all lines of pixels (18) are addressed one by one.

8. A driving circuit for an electrophoretic display as claimed in claim 1, wherein the addressing circuit (16, 10) is arranged for further generating a drive pulse (Vdr) having a energy content in accordance with an optical state to be reached by the associated one of the pixels (18) to display a predetermined image, the drive pulse (Vdr) occurring after the reset pulse (RE).

9. A driving circuit for an electrophoretic display as claimed in claim 7, wherein the addressing circuit (16, 10) is arranged for further generating a further shaking pulse (SP2) in-between the reset pulse (RE) and the drive pulse (Vdr).

10. An electrophoretic display as claimed in claim 8, wherein the addressing circuit (16,10) is arranged for further generating the first mentioned shaking pulse (SP1) comprising the at least one first mentioned preset pulse (PR) having a first duration, and the further shaking pulse (SP2) comprising at least one further preset pulse (PR′) having a second duration being shorter than the first duration.

11. A display apparatus comprising
an electrophoretic display with a plurality of pixels (18) having an electrophoretic material (8, 9) comprising charged particles, each one of the pixels (18) being associated with a respective first electrode (6) and second electrode (5, 5′) for presenting a drive voltage (VD) across each one of the pixels (18) for at least enabling the charged particles to occupy one of two limit positions between the first electrode (6) and the second electrode (5, 5,), and a driving circuit as claimed in claim 1.

12. A method of driving an electrophoretic display with a plurality of pixels (18) having an electrophoretic material (8, 9) comprising charged particles, the pixels (18) being associated with a respective first electrode (6) and second electrode (5) for presenting a drive voltage (VD) across the pixels (18) to at least enable the charged particles to occupy one of two limit positions between the first electrode (6) and the second electrode (5), t
he method of driving comprising addressing (16, 10) for generating the drive voltage (VD) by applying between the first electrode (6) and the second electrode (5):
(i) an reset pulse (RE) having an energy content being larger than required for the charged particles to reach one of the limit positions, and
(ii) a shaking pulse (Sp1) occurring at least partially during the reset pulse (RE), and having during the reset pulse (RE) at least partially a level with an opposite polarity than a level of the reset pulse (RE), the shaking pulse (Sp1) comprising at least one preset pulse (PR) having an energy sufficient to release the charged particles (8, 9) present in one of the limit positions but insufficient to enable said particles (8, 9) to reach the other one of the limit positions.
